(19) United States
(12) Patent Application Publication
(10) Pub. No.: US 2025/0023176 A1
(43) Pub. Date: Jan. 16, 2025

(54) SECONDARY BATTERY MODULE

(71) Applicant: HONDA MOTOR CO., LTD., Tokyo (JP)

(72) Inventors: Tomohiro KINOSHITA, Saitama (JP); Wataru SHIMIZU, Saitama (JP); Wataru HOSHIKAWA, Saitama (JP)

(21) Appl. No.: 18/767,998

(22) Filed: Jul. 10, 2024

(30) Foreign Application Priority Data
Jul. 11, 2023 (JP) 2023-113752

(51) Int. Cl. H01M 50/242; H01M 50/211; H01M 50/289

(52) U.S. Cl. CPC H01M 50/242; H01M 50/211; H01M 50/289; H01M 2220/20

(57) ABSTRACT

A secondary battery module according to an embodiment of the present invention includes: a battery stack in which a plurality of secondary batteries are laminated, and a pair of end plates disposed at both ends in a lamination direction of the battery stack, further including a buffer material disposed at least between either the secondary batteries which are adjacent, or the battery stack and the end plate, in which, in a first direction that is orthogonal to the lamination direction of the battery stack, one end of the buffer material is established as a thick wall part having a large length in the lamination direction, and the other end is established as a thin wall part having a smaller length in the lamination direction than the thick wall part.

This application is based on and claims the benefit of priority from Japanese Patent Application No. 2023-113752, filed on 11 Jul. 2023, the content of which is incorporated herein by reference.

### BACKGROUND OF THE INVENTION

### Field of the Invention

The present invention relates to a secondary battery module.

### Related Art

In recent years, secondary battery modules that contribute to energy efficiency have been researched and developed to ensure that more people have access to affordable, reliable, sustainable, and advanced energy. The secondary battery module is made into a module by combining a plurality of secondary batteries, and generally, includes a cell stack in which a plurality of secondary batteries are laminated, and a pair of end plates arranged on both ends in the lamination direction of the cell stack. Secondary battery modules are being used in applications requiring large current and high voltage, such as for motors driving electric vehicles and hybrid electric vehicles.

In the secondary battery module, it has been considered to arrange a buffer material between the secondary battery and secondary battery, and between the cell stack and end plates, and apply a load (restraining force) in the lamination direction of the battery cell. As the buffer material, spring elastic bodies such as a leaf spring and liquid spring have been known (Patent Document 1).
Patent Document 1: Japanese Unexamined Patent Application, Publication No. 2021-96974

### SUMMARY OF THE INVENTION

However, in the technology related to secondary battery modules, it has been an issue to improve the electrical capacity. In order to improve the electrical capacity of a secondary battery, it has been considered to use a battery accommodating an electrode laminate made by laminating a positive electrode and a negative electrode via a separator, and an electrolytic solution as the secondary battery, and use lithium metal or silicon particles as the negative electrode active material of the negative electrode. However, a lithium secondary battery made using lithium metal or silicon particles greatly increases in the volume of the negative electrode during charging, and greatly decreases in the volume of the negative electrode during discharging. For this reason, when repeating a charge/discharge cycle, the electrolytic solution will leak out from inside the electrode laminate between the electrode laminate and packaging, and a liquid shortage in which the electrolytic solution of the electrode laminate is deficient occurs, and thus there is concern over the cycle characteristic declining.

In order to solve the above problem, the present application has an object of providing a secondary battery module having superior cycle characteristic, even when using secondary batteries for which the volume fluctuates by charging/discharging. This in turn contributes to greater efficiency in energy.

The present inventors have found, by arranging a buffer material with one end being established as a thick wall part having a larger thickness, and the other end being established as a thin wall part having a smaller thickness than the thin wall part, between the secondary battery and secondary battery, or cell stack and end plate, it is possible to solve the above problem, thereby arriving at completion of the present invention. Therefore, the present invention provides the following.

According to a first aspect of the present invention, a secondary battery module includes a battery stack in which a plurality of secondary batteries are laminated, and a pair of end plates disposed at both ends in a lamination direction of the battery stack, further including a buffer material disposed at least between either the secondary batteries which are adjacent, or the battery stack and the end plate, in which, in a first direction that is orthogonal to the lamination direction of the battery stack, one end of the buffer material is established as a thick wall part having a large length in the lamination direction, and the other end is established as a thin wall part having a smaller length in the lamination direction than the thick wall part.

According to the secondary battery module of the first aspect, since the buffer material has the thick wall part and thin wall part, the crushed amount of buffer material changes according to the amount of change in volume of the secondary battery, whereby it becomes possible to control the restraining force applied to the secondary battery, and thus it is possible to adjust the flow of electrolytic solution in the secondary battery during charging/discharging. For this reason, according to the secondary battery module of the first aspect, even when using the secondary battery for which the volume charges by charging/discharging, electrolytic solution shortage hardly occurs, and thus the cycle characteristic is superior.

According to a second aspect of the present invention, in the secondary battery module as described in the first aspect, the secondary battery varies in volume by charging and discharging.

According to the secondary battery module of the second aspect, even when the volume of the secondary battery fluctuates by charging/discharging, since it is possible to adjust the migration direction of the electrolytic solution in the secondary battery by the buffer material being crushed in response to the amount of change in the volume thereof, electrolytic solution shortage hardly occurs, and thus the cycle characteristic is superior.

According to a third aspect of the present invention, in the secondary battery module as described in the first or second aspect, the thin wall part of the buffer material slopes so as to taper off along the first direction, and a sloping degree of the thin wall part relative to the thick wall part is 0.057 to 1.15 degrees.

According to the secondary battery module of the third aspect, since it is possible to adjust the crushed amount of the thin wall part of the buffer material continuously, it is possible to adjust the restraining force applied to the secondary battery so that electrolytic solution shortage does not occur more reliably.

According to a fourth aspect of the present invention, in the secondary battery module as described in any one of the first to third aspects, in a second direction which is orthogonal to the lamination direction and the first direction, the thick wall part of the buffer material is established as an arc shape with a center as a peak.

According to the secondary battery module of the fourth aspect, when the volume of the secondary battery increased, the electrolytic solution in the secondary battery tends to flow in the second direction. In addition, when the volume of the secondary battery decreases, since the electrolytic solution infiltrates the electrode in the secondary battery from the second direction, it becomes possible to evenly supply electrolytic solution in the electrode of the secondary battery.

According to a fifth aspect of the present invention, in the secondary battery module as described in any one of the first to fourth aspects, the buffer material is provided with a groove in a plane along a second direction orthogonal to the lamination direction and the first direction, and along the first direction, and when defining a length in the first direction of the plane as A, and defining a length in the second direction as C, the groove is a curved shape linking a center point in the second direction of ends on a side of the thick wall part in the first direction, and two points at positions which are a length ⅔A towards a side of the thick wall part from both ends in the second direction of ends on a side of the thin wall part in the first direction, or is a curved shape linking the center point and two points at positions which are a length ⅕C towards the second direction from both ends which are ends on a side of the thin wall part in the first direction.

According to the secondary battery module of the fifth aspect, when the groove is provided in a face of the buffer material which contacts with the secondary battery, and the volume of the secondary battery increases, since the pressure applied to the electrodes in the secondary battery from a portion of the buffer material at which the groove is not provided, the electrolytic solution in the secondary battery tends to migrate to a portion opposing the portion of the buffer material at which the groove is provided. In addition, when the volume of the secondary battery decreases, since the electrolytic solution infiltrates into the electrodes of the secondary battery from a portion opposing the portion of the buffer material at which the groove is provided, it becomes possible to evenly supply the electrolytic solution into the electrodes of the secondary battery.

According to a sixth aspect of the present invention, in the secondary battery module as described in any one of the first to fifth aspects, the buffer material is disposed so that the thin wall part is positioned more to an upper side in a gravity direction than the thick wall part.

According to the secondary battery module of the sixth aspect, when the volume of the secondary battery increases, since the restraining force applied to the secondary battery increases from below to upwards, it is possible to have the electrolytic solution migrate with anisotropy above the secondary battery. On the other hand, when the volume of the secondary battery decreases, since the restraining force applied to the secondary battery lowers from above to below, it is possible to have the electrolytic solution migrate from above to below the secondary battery by the own weight of the electrolytic solution. For this reason, even when repeating charging/discharging, electrolytic solution shortage hardly occurs, and thus the cycle characteristic is superior.

According to a seventh aspect of the present invention, in the secondary battery module as described in any one of the first to sixth aspects, the secondary battery includes an electrode laminate in which a positive electrode and a negative electrode are laminated via a separator, an electrolytic solution, and a packaging which accommodates the electrode laminate and the electrolytic solution, and the secondary battery is disposed so that a lamination direction of the electrode laminate matches the lamination direction of the battery stack.

According to the secondary battery module of the seventh aspect, since the lamination direction of the electrode laminate for which the volume change of the secondary battery is great, and the lamination direction of the battery stack match, it is possible to apply a fixed pressure to the secondary battery irrespective of the state of charge/discharge of the secondary battery. For this reason, the charge/discharge capacity of the secondary battery is stable.

According to an eighth aspect of the present invention, in the secondary battery module as described in the seventh aspect, the negative electrode increases in volume by charging, and decreases in volume by discharging.

According to the secondary battery module of the eighth aspect, since it is possible to use lithium metal or silicon particles as the negative electrode active material, the capacity of the secondary battery increases.

According to the present application, it is possible to provide a secondary battery module having superior cycle characteristic, even when using secondary batteries for which the volume fluctuates by charging/discharging.

### BRIEF DESCRIPTION OF THE DRAWINGS

FIG. 1 is a front view showing a discharged state of a secondary battery module according to an embodiment of the present invention;

FIG. 2 is a bottom view of the secondary battery module shown in FIG. 1;

FIG. 3A is a front view of a buffer material used in the secondary battery module shown in FIG. 1;

FIG. 3B is a perspective view of the buffer material used in the secondary battery module shown in FIG. 1;

FIG. 4A is a cross-sectional view showing a discharged state of a secondary battery used in the secondary battery module according to the embodiment of the present invention;

FIG. 4B is a cross-sectional view showing a charged state of a secondary battery used in the secondary battery module according to the embodiment of the present invention;

FIG. 5 is a front view showing a charged state of the secondary charge module shown in FIG. 1;

FIG. 6 is a bottom view of the secondary charge module shown in FIG. 5;

FIG. 7 is a bottom view of the discharged state of the secondary battery module according to a modified example of the present invention;

FIG. 8 is a bottom view of a charged state of the secondary battery module shown in FIG. 7; and

FIG. 9 is a perspective view for explaining the shape of a modified example of the buffer material used in the secondary battery module of the present invention.

### DETAILED DESCRIPTION OF THE INVENTION

Hereinafter, embodiments of the present invention will be explained while referencing the drawings. It should be noted that, in the following drawings, the X direction is a lamination direction in which stacking the secondary batteries, the Y direction is a first direction orthogonal to the X direction, and the Z direction indicates a second direction orthogonal to the X direction and the Y direction. The Y direction is also the gravity direction. In addition, in the present embodiment, a secondary battery 10 shall have a volume that decreases in the discharged state, and increases in the charged state. It should be noted that discharged state indicates the state immediately after manufacture of the secondary battery.

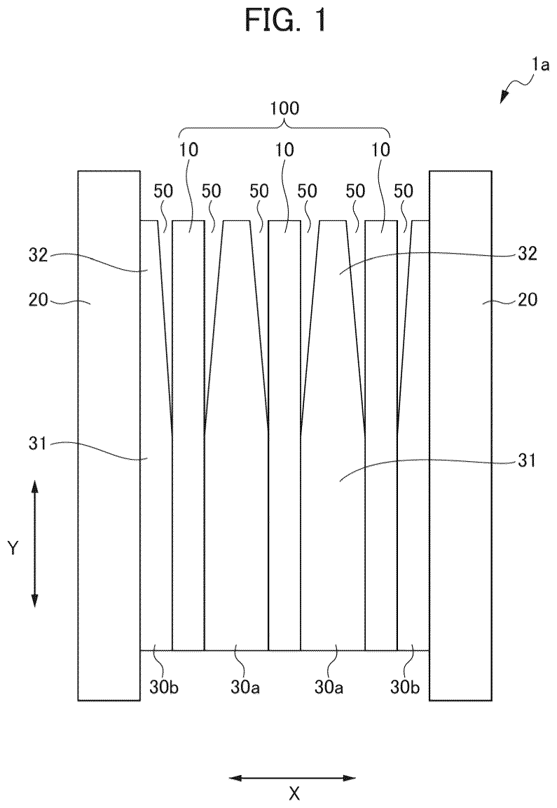

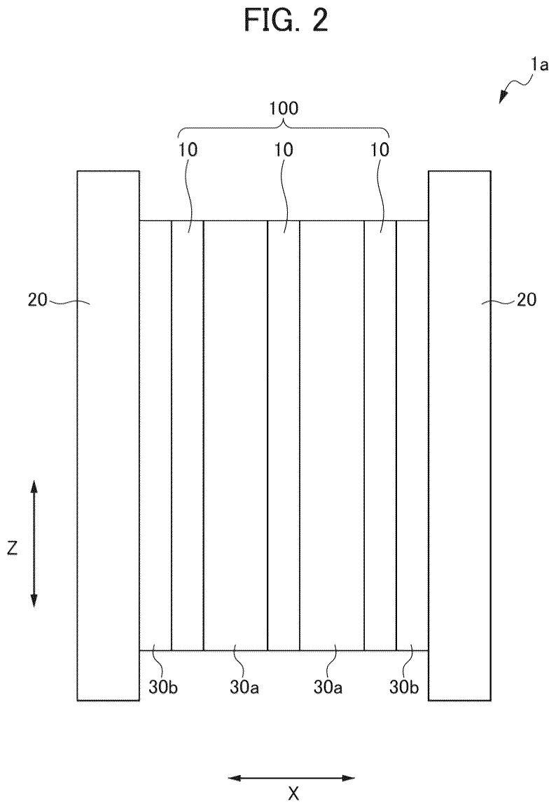

A secondary battery module 1a which is an embodiment of the present invention has a battery stack 100 in which three secondary batteries 10 are laminated, and a pair of end plates 20 arranged at both ends in the lamination direction (X direction) of the battery stack 100, as shown in FIGS. 1 and 2. Between adjacent secondary batteries 10, a buffer material 30a is arranged, and between the battery stack 100 and end plate 20, a buffer material 30b is arranged. The secondary battery 10 is the discharged state, which is a state with decreased volume.

The pair of end plates 20 are restrained by fastening members (not shown). The pair of end plates 20 restrain the battery stack 100 in the X direction by transmitting the restraining force applied by the fastening members to the battery stack 100. The material of the end plates 20 is not particularly limited, and it is possible to use various materials which are being used in the end plates of battery modules.

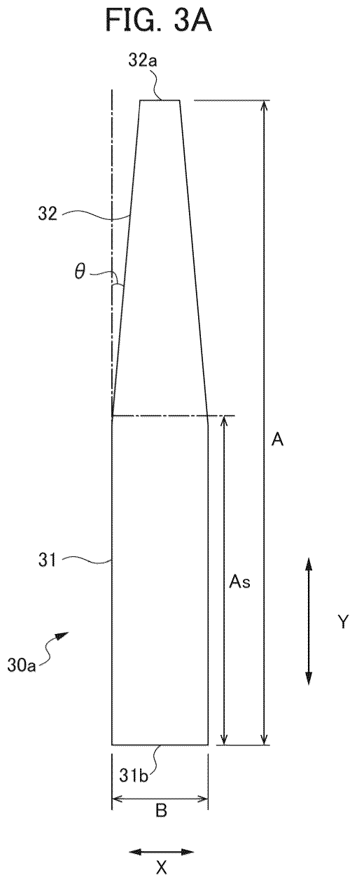

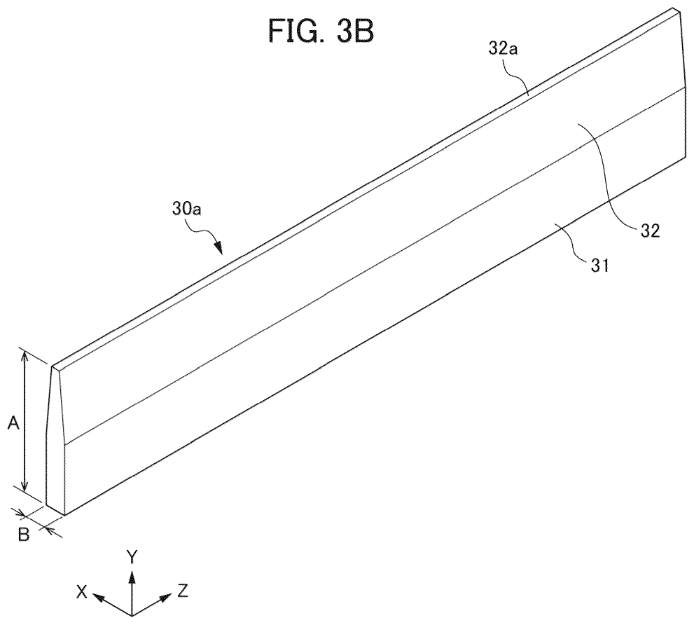

The buffer materials 30a, 30b have a function of mitigating the restraining force applied to the secondary battery 10. In the Y direction (first direction), the buffer materials 30a, 30b have a thick wall part 31 having a greater length in the X direction (lamination direction), and a thin wall part 32 having a smaller length in the X direction than the thick wall part 31, as shown in FIGS. 3A and B. The thick wall part 31 always contacts the secondary battery. The thin wall part 32 forms a gap 50 separated from the secondary battery 10, by sloping so as to taper off along the Y direction. In the Y direction (gravity direction), the secondary battery module 1a is arranged so that the thin wall part 32 of the buffer materials 30a, 30b is positioned above, and the thick wall part 31 is positioned below. The buffer material 30b is the same as the buffer material 30a except that it shall be a shape which makes ½ the buffer material 30a along the Y direction; therefore, the buffer material 30a will be taken as an example to explain in detail.

The sloping angle θ (refer to FIG. 3A) of the thin wall part 32 relative to the thick wall part 31 of the buffer material 30a is not particularly limited; however, it is within the range of 0.057 to 1.15 degrees. The length A (refer to FIG. 3A) in the Y direction (first direction) of the buffer material 30a may be the same as the secondary battery 10, for example. The length As (refer to FIG. 3A) in the Y direction of the thick wall part 31 may be within the range of 20 to 80% relative to the length A in the Y direction of the buffer material 30a, for example. When the length As in the Y direction of the thick wall part 31 is at least 20%, displacement between the secondary battery 10 and buffer material 30a will hardly occur, even when the volume of the secondary battery 10 fluctuates. In addition, when the length As in the Y direction of the thick wall part 31 is no more than 80%, since the range of the thin wall part 32 becomes wider, the region of the gap 50 formed with the buffer material 30a becomes wider in a state in which the volume of the secondary battery 10 has decreased.

The length B (refer to FIG. 3A) in the X direction (lamination direction) of a bottom 31a of the thick wall part 31 of the buffer material 30a may be within the range of 10 to 40% relative to the length in the X direction of the secondary battery 10, for example. In addition, the ratio of the length in the X direction of the thin wall part 32 relative to the length B in the X direction of the bottom 31a of the thick wall part 31 is decided by the sloping angle θ of the thin wall part 32, length A in the Y direction of the buffer material 30a, and length As in the Y direction of the thick wall part 31.

The material of the buffer materials 30a, 30b can employ a rubber material and jointly use of a spring and plastic. As examples of the rubber material, rubbers such as natural rubber, diene rubber, and non-diene rubber can be exemplified. The Young's modulus of the buffer materials 30a, 30b may be within the range of 0.002 to 4 GPa, for example.

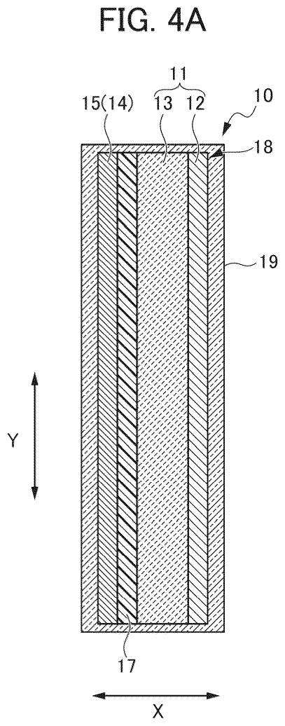

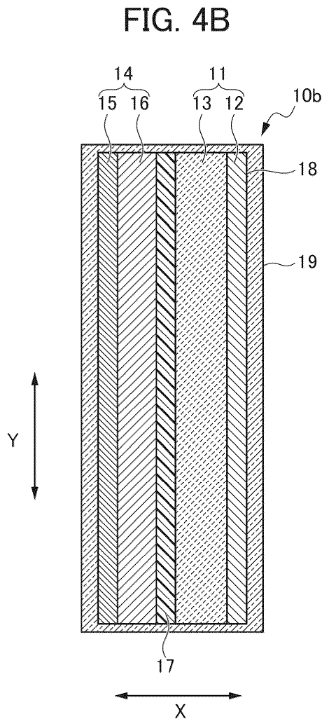

The secondary battery 10, as shown in FIG. 4A, includes an electrode laminate 18 stacking positive electrodes 11 and negative electrodes 14 via a separator 17, electrolytic solution (not shown), and a packaging 19 which accommodates the electrode laminate 18 and electrolytic solution. The secondary battery 10 is established as a lithium metal secondary battery made using lithium metal as the negative electrode active material. The secondary battery 10 is arranged so that the lamination direction of the electrode laminate 18 matches the X direction of the battery stack 100 (lamination direction).

The positive electrode 11 has a positive electrode collector 12 and a positive electrode active material layer 13. The positive electrode collector 12 is drawn to outside by a positive electrode lead terminal (not shown). The material of the positive electrode collector 12 can use Al, for example.

The positive electrode active material layer 13 contains the positive electrode active material. As examples of the positive electrode active material, lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganate (LiMn₂O₄), Li₁₊ₓMn_{2-x-y}M_{y}O₄ (x+y=2, M=at least one selected from Al, Mg, Co, Fe, Ni and Zn), lithium titanate (oxide containing Li and Ti), lithium metal phosphate (LiMPO₄, M=at least one selected from Fe, Mn, Co, and Ni), etc. can be exemplified. The positive electrode active material layer 13 may contain various additives used as a material of the positive electrode active material layer such as binder and conduction aids.

The negative electrode 14 has a negative electrode collector 15. The negative electrode collector 15 is drawn to the outside by a negative electrode lead terminal (not shown). The material of the negative electrode collector 15 can use Cu, for example. Li foil may be laminated on the surface of the negative electrode collector 15.

In the negative electrode 14, the negative electrode active material layer 16 (lithium metal layer) is generated by charging, as shown in FIG. 4B. For this reason, in the negative electrode 14 of the secondary battery 10b after charging, the thickness in the lamination direction of the electrode laminate 18 becomes thicker, and the volume increases. In the secondary battery 10b after charging, the negative electrode active material layer 16 dissolves and disappears by discharging, and thus the volume decreases.

The electrolytic solution contains organic solvent and electrolyte. The organic solvent can use a cyclic carbonate, chain carbonate, cyclic ether, chain ether, hydrofluoroether, aromatic ether, sulfone, cyclic ester, chain carboxylic acid ester, and nitrile, for example. As examples of the cyclic carbonate, ethylene carbonate, propylene carbonate, vinylene carbonate, fluoroethylene carbonate, etc. can be exemplified. As examples of the chain carbonate, dimethyl carbonate, diethyl carbonate, ethyl methyl carbonate, etc. can be exemplified. As examples of the cyclic ether, tetrahydrofuran, 2-methyltetrahydrofuran, tetrahydropyran, 1,3-dioxolane, 4-methyl1,3-dioxolane, etc. can be exemplified. As examples of the chain ether, 1,2-dimethoxyethane, 1,2-diethoxyethane, ethoxymethoxyethane, diethyl ether, etc. can be exemplified. As examples of the hydrofluoroether, 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl)ether, 1,2-bis(1,1,2,2-tetrafluoroethoxy)ethane, etc. can be exemplified. As an example of the aromatic ether, anisole can be exemplified. As examples of the sulfone, sulfolane, methylsulfolane, etc. can be exemplified. As examples of the cyclic ester, γ-butyrolactone, etc. can be exemplified. As examples of the chain carboxylic acid ester, acetate ester, butyrate ester, propionate ester, etc. can be exemplified. As examples of the nitrile, acetonitrile, propionitrile, etc. can be exemplified. The organic solvent may use one type individually, or may use by combining two or more types.

The electrolyte is the supply source of lithium ions, which are the charge transfer medium, and contains lithium salt. As examples of the lithium salt, LiPF₆, LiBF₄, LiClO₄, LiAsF₆, LiCF₃SO₃, LiC(CF₃SO₂)₃, LiN(CF₃SO₂)₂ (LiTFSI), LiN(FSO₂)₂ (LiFSI), LiBC₄O₈, etc. can be exemplified. The lithium salt may use one type individually, or may use by combining two or more types. The concentration of electrolyte is within the range of 1.0 mol/L to 4.0 mol/L, for example.

The packaging 19 is established to be expandable to follow an increase and decrease in volume of the negative electrode 14 due to charging and discharging. As the material of the packaging 19, a laminate film can be used. As the laminate film, it is possible to use a laminate film of 3-layer structure in which an inside resin layer, metal layer and outside resin layer are laminated from inside in this order. The outside resin layer is a polyamide layer, for example, the metal layer is an aluminum layer, for example, and the outside resin layer may be a polypropylene layer, for example.

By charging, when the volume of the secondary battery 10 in the battery stack 100 increases, the thick wall part 31 of the buffer materials 30a, 30b is crushed in the X direction by the compressive force due to the volume increase. By the thick wall part 31 being crushed, a repulsive force against the compressive force generates, the restraining force applied from the thick wall part 31 to the secondary battery 10 increases, and the restraining force becomes greater inside of the secondary battery 10. On the other hand, since there is a gap 50 between the thin wall part 32 of the buffer material 30a, 30b and the secondary battery 10, compressive force is not applied to the thin wall part 32 at the early stage of charging. For this reason, at a charging early stage, restraining force is applied to a portion of the secondary battery 10 opposing the thick wall part 31 of the electrode laminate 18, and the electrolytic solution migrates upwards in the Y direction (gravity direction). Furthermore, accompanying the volume increase in the secondary battery 10, when the thin wall part 32 contacts the secondary battery 10 from below in the Y direction, the thin wall part 32 is also crushed. When the thin wall part 32 is crushed, the restraining force is applied to the secondary battery 10 from the thin wall part 32, and the electrolytic solution of the electrode laminate 18 on the inside of the secondary battery 10 opposing the thin wall part 32 migrates upwards in the Y direction. Then, when the entire thin wall part 32 is crushed, it is pushed out of the electrode laminate 18.

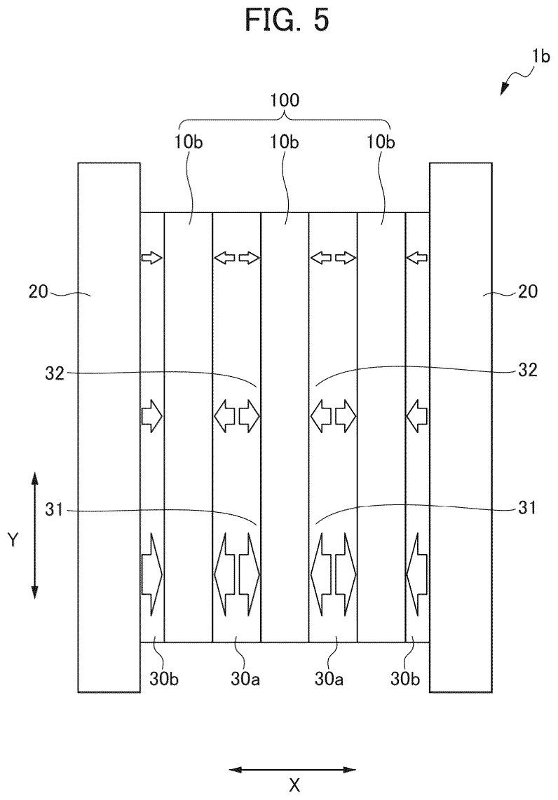

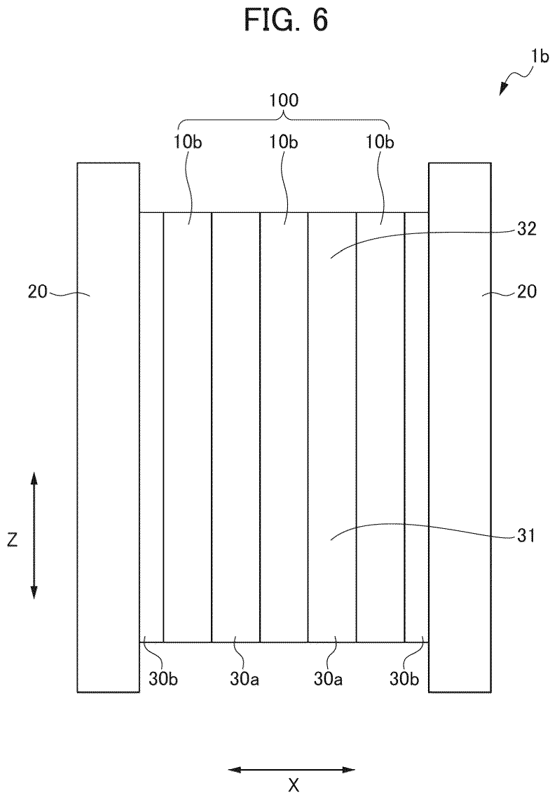

As shown in FIG. 5, when viewing the front side (plane along X-Y directions) of the secondary battery module 1b after charging completion, the restraining force applied from the buffer material 30a, 30b to the secondary battery 10 is the highest at the portion opposing the thick wall part 31, and becomes weaker as the portion opposing the thin wall part 32 moves ahead (arrow in FIG. 5 indicates the restraining force greater as the thickness is greater). On the other hand, as shown in FIG. 6, at the bottom surface of the secondary battery module 1b after charging completion, since the compressive force by the secondary battery 10b is applied evenly to the thick wall part 31 of the buffer material 30a, 30b, the crushed amount is uniform. Consequently, the restraining force applied from the thick wall part 31 of the buffer material 30a, 30b to the secondary battery 10b is uniform.

When discharging the charged secondary battery 10b, and the volume of the secondary battery 10b gradually decreases, the compressive force applied from the secondary battery 10b to the buffer materials 30a, 30b becomes lower. The crushed amounts of the thick wall part 31 and thin wall part 32 of the buffer materials 30a, 30b thereby becomes smaller, and the gap 50 is formed between the thin wall part 32, secondary battery 10b and thin wall part 32. When the gap 50 is formed, the electrolytic solution infiltrates inside of the electrode laminate 18 from this gap 50. The electrolytic solution infiltrating inside of the electrode laminate 18 is flowed from the upper end in the Y direction downwards by its own weight, and is uniformly supplied to the positive electrode 11 and negative electrode 14.

According to the secondary battery module 1 of the present embodiment, since the buffer material 30 has the thick wall part 31 and thin wall part 32, when the volume of the secondary battery 10 increases, it is possible to regulate the flow of electrolytic solution in the secondary battery 10 during charge/discharge, since it becomes possible to control the restraining pressure applied to the secondary battery 10. For this reason, the secondary battery module 1 of the present embodiment, even if using a secondary battery 10 for which the volume varies by charge/discharge, electrolytic solution shortage hardly occurs, and thus the cycle characteristic is superior. In the secondary battery module 1 of the present embodiment, the thin wall part 32 of the buffer materials 30a, 30b slopes so as to taper off along the Y direction (first direction), and the sloping angle of the thin wall part 32 relative to the thick wall part 31 is set to 0.057 to 1.15 degrees; therefore, it is possible to adjust the crushed amount of the buffer material at the contact region between the thin wall part 32 of the buffer materials 30a, 30b and the secondary battery 10 continuously. For this reason, it is possible to adjust the restraining force applied to the secondary battery 10, so that electrolytic solution shortage will not occur more reliably. Furthermore, according to the secondary battery module 1 of the present embodiment, since the thin wall part 32 of the buffer materials 30a, 30b is arranged so as to be positioned more to the upper side in the gravity direction than the thick wall part 31, when the volume of the secondary battery 10 increases, it is possible to have the electrolytic solution migrate with anisotropy above the secondary battery 10. On the other hand, when the volume of the secondary battery 10 decreases, it is possible to have the electrolytic solution migrate from above to below the secondary battery 10 by the own weight of the electrolytic solution. For this reason, even when repeating charging/discharging, electrolytic solution shortage hardly occurs, and thus the cycle characteristic is superior.

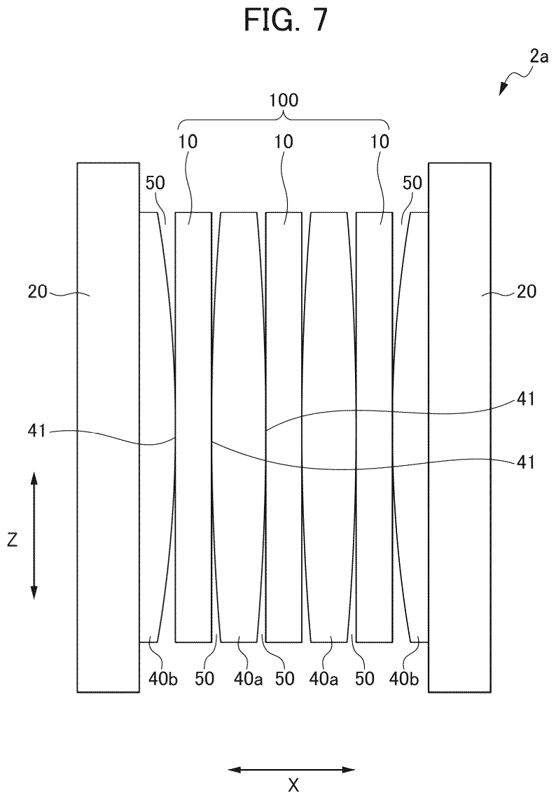

With the secondary battery module la of the present embodiment, the bottom of the thick wall part 31 of the buffer materials 30a, 30b is made rectangular; however, the bottom of the thick wall part 31 of the buffer materials 30a, 30b may curve. FIG. 7 shows a modified example made by curving the bottom of the buffer materials 30a, 30b.

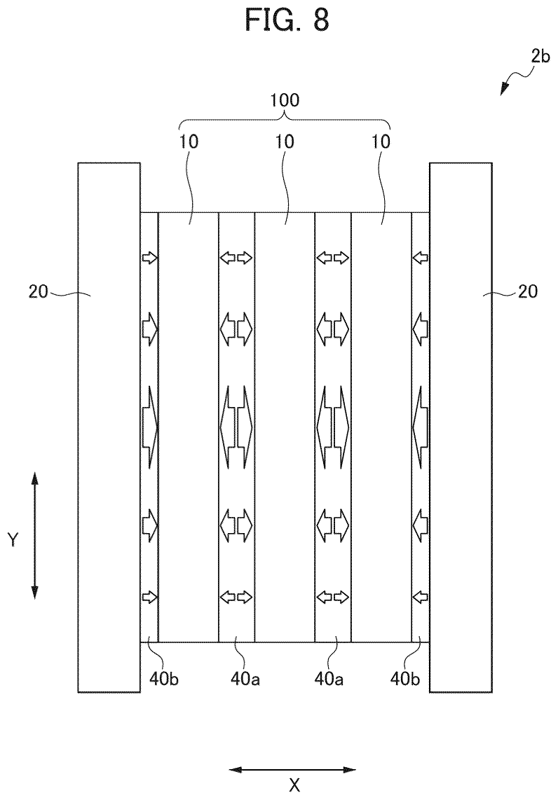

With the secondary battery module 2a shown in FIG. 7, the bottom of buffer materials 40a, 40b is made an arc shape with the center in the Z direction (second direction) as a peak. The center in the Z direction of the thick wall part 31 contacts with the secondary battery 10 which is the discharged state, and thus is a state in which the volume decreased, and both ends in the Z direction distance from the secondary battery 10 to form the gap 50. By charging, when the volume of the secondary battery 10 increases in the X direction, the buffer materials 30a, 30b are pushed in the X direction by the secondary battery 10, and as the length in the X direction of the thick wall part 31 gradually decreases, the interval of the gap 50 narrows. In the secondary battery module 2b after charging completion, the secondary battery 10b and the thin wall part 32 in the Z direction of the buffer materials 30a, 30b contact, as shown in FIG. 8. On the secondary battery 10b after charging completion, pressure is applied from the buffer materials 30a, 30b. The pressure applied from the buffer materials 30a, 30b becomes the highest at the center in the Z direction, and weakens as approaching both ends in the Z direction (arrow in FIG. 8 indicates the restraining force pressure increases as the thickness increases), as shown in FIG. 8.

According to the secondary battery module 2 of the present modified example, when the volume of the secondary battery 10 increases, the electrolytic solution in the electrode laminate 18 tends to flow in the second direction. In addition, when the volume of the secondary battery 10 decreases, since the electrolytic solution infiltrates into the electrode laminate 18 from the second direction, it becomes possible to more evenly supply electrolytic solution into the electrode laminate 18 of the secondary battery 10.

With the secondary battery module 1a of the present embodiment, although the lateral face of the buffer materials 30a, 30b contacting with the secondary battery 10 is established as planar, a groove may be provided in the lateral face of the buffer materials 30a, 30b contacting with the secondary battery 10.

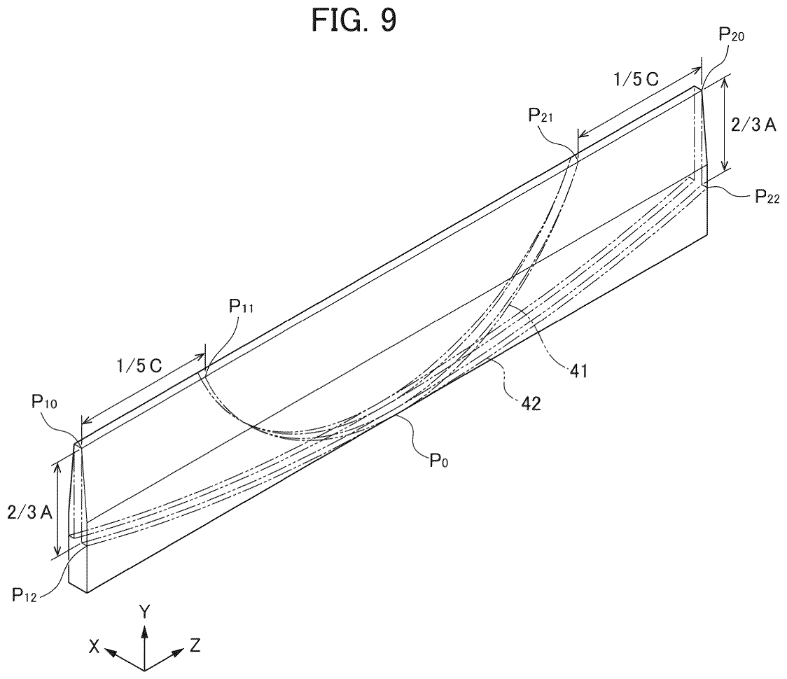

In a buffer material 40c shown in FIG. 9, a groove 41 and a groove 42 are shown by virtual lines. The groove 41 and groove 42 are provided in the lateral face of the buffer material 40c contacting with the secondary battery 10, i.e. Y-Z plane along the Y direction (first direction) and Z direction (second direction). Defining the length in the Y direction of this Y-Z plane as A, and defining the length in the Z direction as C, the groove 41 is established as a curved shape linking a center point P₀ in the Z direction of the thick wall part-side end in the Y direction of the Y-Z plane, and two points P₁₁, P₂₁ at positions which are a length ⅕C towards the Z direction from both ends P₁₀, P₂₀ of the thin wall part-side end in the Y direction. The groove 42 is established as a curved shape linking the center point P₀ in the Z direction of the thick wall part-side end in the Y direction, and the two points P₁₂, P₂₂ at positions which are a length ⅔A towards the thick wall part side from both ends in the Z direction of the thin wall part side end in the Y direction. The groove 41 is a curved shape that swells outwards from the center point P₀ towards the points P₁₁, P₂₁ of the ends, and the groove 42 is a curved shape swelling outwards from the center point P₀ towards the points P₁₂, P₂₂. The groove may be an arc shape. The length in the X direction of the grooves 41, 42 is within the range of 0.1 to 2.0 mm from the surface of the thick wall part 31, for example.

In the secondary battery module made using the buffer material 40c, when the grooves 41, 42 are provided in the Y-Z plane which is a plane contacting with the secondary battery 10, and the volume of the secondary battery 10 increases, since the pressure applied to the secondary battery 10 from a portion of the buffer material 40c in which the grooves 41, 42 are not provided increases, the electrolytic solution in the electrode laminate 18 tends to migrate to a portion opposing the portion of the buffer material 40c in which the groove is provided. In addition, when the volume of the secondary battery 10 decreases, since the electrolytic solution infiltrates into the electrode laminate 18 from a portion opposing the portion of the buffer material 40c at which the groove is provided, it becomes possible to evenly supply electrolytic solution into the electrode laminate 18 of the secondary battery 10. The ends of the groove 41 are defined as points P₁₁, P₂₁, the ends of the groove 42 are defined as points P₁₂, P₂₂; however, the positions of the ends are not limited thereto. The ends of the groove may be between P₁₀ and P₁₁, and between P₂₀ and P₂₁, or may be between P₁₀ and P₁₂, and between P₂₀ and P₂₂. The positions of the ends of the groove may be symmetrical positions with the center point P₀ as the center.

Preferred embodiments of the present invention have been explained above. However, the present invention is not to be limited to the above embodiments, and modifications thereto are possible where appropriate. For example, in the present embodiment, the length of the thin wall part 32 of the buffer materials 30a, 30b in the X direction continuously decreases so as to taper off along the Y direction; however, the shape of the thin wall part 32 is not limited thereto. The length in the X direction of the thin wall part 32 may decrease step-wise.

In addition, in the present embodiment, the secondary battery 10 is established as a lithium metal secondary battery made using lithium metal as the negative electrode active material; however, the secondary battery 10 is not limited thereto. Silica particles may be used as the negative electrode active material of the secondary battery 10. In addition, the secondary battery 10 may be a battery for which the volume does not change by charging/discharging.

### EXPLANATION OF REFERENCE NUMERALS

1a, 1b, 2a, 2b secondary battery module
10, 10b secondary battery
11 positive electrode
12 positive electrode collector
13 positive electrode active material layer
14 negative electrode
15 negative electrode collector
16 negative electrode active material layer
17 separator
18 electrode laminate
19 packaging
20 end plate
30a, 30b, 40a, 40b, 40c buffer material
31 thick wall part
31a bottom
32 thin wall part
32a leading end
41, 42 groove
50 gap

What is claimed is:

1. A secondary battery module comprising a battery stack in which a plurality of secondary batteries are laminated, and a pair of end plates disposed at both ends in a lamination direction of the battery stack,
further comprising a buffer material disposed at least between either the secondary batteries which are adjacent, or the battery stack and the end plate,
wherein, in a first direction that is orthogonal to the lamination direction of the battery stack, one end of the buffer material is established as a thick wall part having a large length in the lamination direction, and the other end is established as a thin wall part having a smaller length in the lamination direction than the thick wall part.

2. The secondary battery module according to claim 1, wherein the secondary battery varies in volume by charging and discharging.

3. The secondary battery module according to claim 1, wherein the thin wall part of the buffer material slopes so as to taper off along the first direction, and a sloping degree of the thin wall part relative to the thick wall part is 0.057 to 1.15 degrees.

4. The secondary battery module according to claim 1, wherein, in a second direction which is orthogonal to the lamination direction and the first direction, the thick wall part of the buffer material is established as an arc shape with a center as a peak.

5. The secondary battery module according to claim 1, wherein the buffer material is provided with a groove in a plane along a second direction orthogonal to the lamination direction and the first direction, and along the first direction, and
wherein, when defining a length in the first direction of the plane as A, and defining a length in the second direction as C,
the groove is a curved shape linking a center point in the second direction of ends on a side of the thick wall part in the first direction, and two points at positions which are a length ⅔A towards a side of the thick wall part from both ends in the second direction of ends on a side of the thin wall part in the first direction, or is a curved shape linking the center point and two points at positions which are a length ⅕C towards the second direction from both ends which are ends on a side of the thin wall part in the first direction.

6. The secondary battery module according to claim 1, wherein the buffer material is disposed so that the thin wall part is positioned more to an upper side in a gravity direction than the thick wall part.

7. The secondary battery module according to claim 1, wherein the secondary battery includes an electrode laminate in which a positive electrode and a negative electrode are laminated via a separator, an electrolytic solution, and a packaging which accommodates the electrode laminate and the electrolytic solution, and
wherein the secondary battery is disposed so that a lamination direction of the electrode laminate matches the lamination direction of the battery stack.

8. The secondary battery module according to claim 7, wherein the negative electrode increases in volume by charging, and decreases in volume by discharging.
